(19) United States
(12) Patent Application Publication
(10) Pub. No.: US 2012/0053077 A1
(43) Pub. Date: Mar. 1, 2012

(54) METHOD OF MEASURING BIO-MATERIAL USING POLYMER THIN FILM AND MAGNETIC BEADS

(75) Inventor: Hyo-Bong HONG, Daejeon (KR)

(73) Assignee: Electronics and Telecommunications Research Institute, Daejeon (KR)

(21) Appl. No.: 13/221,295

(22) Filed: Aug. 30, 2011

(30) Foreign Application Priority Data
Aug. 31, 2010 (KR) 10-2010-0084963

(51) Int. Cl. C40B 30/04; C40B 60/12; C40B 50/18

(52) U.S. Cl. 506/9; 506/32; 506/39

(57) ABSTRACT

Disclosed is a method of measuring a bio-material using a polymer thin film and magnetic beads, including immobilizing a bio-material on a polymer thin film including nylon or nitrocellulose film; attaching a chemical functional group to the magnetic beads and then reacting it with the bio-material on the polymer thin film; and measuring the bio-material using a magnetic bead reader for detecting the magnetic beads.

### BACKGROUND OF THE INVENTION

1. Field of the Invention

The present invention relates to a method of measuring a bio-material using a polymer thin film and magnetic beads.

This application claims the benefit of Korean Patent Application No. 10-2010-0084963, filed Aug. 31, 2010, which is hereby incorporated by reference in its entirety into this application.

2. Description of the Related Art

The analysis of materials such as DNAs and proteins which are usable as a biomarker is regarded as very important in the fields of life science, medical science, chemistry, chemical engineering, etc. A variety of analysis methods have been developed depending on the kind of analyte. However, almost all biochemical analysis methods except for analysis of molecular weight (electrophoresis, mass spectrometry for analyzing MALDI-TOF, etc.) mainly include, in the case of DNAs, using complementary bonds by use of cDNA (complementary DNA), and, in the case of proteins, using specific bonds between predetermined proteins such as antibodies and various chemical materials (most organic materials) or using enzyme-substrate reactions.

The very fundamental principle of such methods is that one among measurement targets or materials is immobilized on glass, a silicon wafer, plastic, etc., regardless of the analyte (both DNA and proteins may be applied), after which physical and chemical changes of a labeling compound are measured using light analysis or electrochemical analysis thus judging the presence or absence of the subject material.

Based on such a principle, methods of measuring the degree of activation of a measurement target (or a measurement material) using a fluorescent/luminescent/chromophoric material or analysis methods using quantum dots (QD) or magnetic beads are widely employed. Among these, however, the methods using magnetic beads are problematic because a device able to measure magnetic beads is very limited, and thus analysis methods using a small analytical device are being developed but many limitations are imposed on actual users who adopt exclusive use of columns or chips and also many samples cannot be treated at once.

### SUMMARY OF THE INVENTION

Accordingly, an object of the present invention is to provide a method of measuring a bio-material using a polymer thin film and magnetic beads, which enables array analysis and also continuous analysis.

In order to accomplish the above object, the present invention provides a method of measuring a bio-material using a polymer thin film and magnetic beads, comprising immobilizing a bio-material on a polymer thin film comprising nylon or nitrocellulose; attaching a chemical functional group to the magnetic beads and then reacting it with the bio-material on the polymer thin film; and measuring the bio-material using a magnetic bead reader for detecting the magnetic beads.

The bio-material may be DNA or a protein.

The protein may be an antigen-antibody complex.

The polymer thin film enables the bio-material to be immobilized in an array form.

When the bio-material is DNA, the chemical functional group may be cDNA (complementary DNA).

When the bio-material is a protein, the chemical functional group may be a secondary antibody.

The magnetic beads may have a size of 2.8˜50 nm.

In addition, the present invention provides a method of immobilizing a bio-material on a polymer thin film, comprising disposing the bio-material on the polymer thin film; and adding the bio-material to the polymer thin film and creating a vacuum atmosphere.

The bio-material may be DNA or a protein.

The protein may be an antigen-antibody complex.

The polymer thin film may be nylon or nitrocellulose.

In this method, immobilizing may be performed by means of a moving force based on a difference in pressure occurring in the course of creating the vacuum atmosphere.

In addition, the present invention provides an apparatus for measuring a bio-material, comprising an immobilization part comprising a nylon or nitrocellulose polymer thin film having a bio-material immobilized thereon; a reaction part for reacting a chemical functional group attached to magnetic beads with the bio-material; and a measurement part for detecting the magnetic beads using a magnetic bead reader.

When the bio-material is DNA, the chemical functional group may be cDNA (complementary DNA).

When the bio-material is a protein, the chemical functional group may be a secondary antibody.

### BRIEF DESCRIPTION OF THE DRAWINGS

The features and advantages of the present invention will be more clearly understood from the following detailed description taken in conjunction with the accompanying drawings, in which:

FIG. 1 is a flowchart showing a process of measuring a bio-material using a polymer thin film and magnetic beads according to the present invention;

FIG. 2 is a flowchart showing a process of immobilizing a bio-material on a polymer thin film according to the present invention;

FIG. 3 is a block diagram showing an apparatus for measuring a bio-material using a polymer thin film and magnetic beads according to the present invention;

FIG. 4 is a schematic view showing the bond of a polymer thin film and magnetic beads to detect proteins in the process of measuring a bio-material according to the present invention; and

FIG. 5 is a graph showing results of measuring a virus protein of the H5N1 virus using the process of measuring a bio-material according to the present invention.

### DESCRIPTION OF SPECIFIC EMBODIMENTS

Hereinafter, a detailed description will be given of the present invention.

According to the present invention, a method of measuring a bio-material using a polymer thin film and magnetic beads includes immobilizing a bio-material on nylon or nitrocellulose; attaching a chemical functional group to magnetic beads and reacting it with the bio-material on nylon or nitrocellulose; and measuring the bio-material using a magnetic bead reader for detecting the magnetic beads.

In the method of measuring a bio-material according to the present invention, the bio-material immobilized on the polymer thin film such as nylon, nitrocellulose, etc., may include DNA, proteins, etc., and the immobilization may be carried out by means of an electrostatic force between the polymer thin film and the bio-material.

The immobilization of the bio-material on the polymer thin film is carried out by means of a force caused by the portion including the polymer thin film and the bio-material being made vacuous using a P-pump.

The nylon or nitrocellulose polymer thin film enables the analysis of the bio-material immobilized in an array form that was not conventionally analyzed using magnetic beads.

In the method of measuring a bio-material using a polymer thin film and magnetic beads according to the present invention, the chemical functional group is attached to the magnetic beads, and then reacted with the bio-material on nylon or nitrocellulose.

As such, in the case where the bio-material is DNA, the chemical functional group is cDNA (complementary DNA), and in the case where the bio-material is a protein, the chemical functional group is a secondary antibody in which the secondary antibody is bonded with an antigen, an antigen bound to an antibody, or an antibody.

The magnetic beads function as a labeling compound, and are inexpensive and a decrease in activity thereof is low upon change in temperature or exposure to light. The size of the magnetic beads falls in the range of 2.8˜50 nm.

In the method of measuring a bio-material using a polymer thin film and magnetic beads according to the present invention, the magnetic bead reader for detecting magnetic beads is used to measure the bio-material. The bio-material is represented by a voltage value by means of the magnetic beads having the chemical functional group attached thereto. The voltage value may increase in proportion to an increase in the amount of the bio-material.

In addition, the present invention provides a method of immobilizing a bio-material on a polymer thin film, comprising preparing a bio-material, disposing the bio-material on the polymer thin film, adding the bio-material to the polymer thin film, and creating a vacuum atmosphere. In this method, the bio-material may be immobilized on the polymer thin film by means of a moving force based on a difference in pressure occurring in the course of creating the vacuum atmosphere.

As such, the bio-material may include DNA, proteins, etc., in which the proteins may include an antigen-antibody complex.

The polymer thin film may include nylon, nitrocellulose, etc.

In addition, the present invention provides an apparatus for measuring a bio-material, comprising an immobilization part including nylon or nitrocellulose having a bio-material immobilized thereon, a reaction part for reacting a chemical functional group attached to magnetic beads with the bio-material, and a measurement part for detecting the magnetic beads using a magnetic bead reader.

The immobilization part is accomplished by means of a moving force generated while the polymer thin film having the bio-material added thereto is made vacuous in order to immobilize the bio-material on the polymer thin film such as nylon or nitrocellulose, and includes the polymer thin film and the bio-material.

In the reaction part, in the case where the bio-material bound to the polymer thin film is for example DNA, the chemical functional group is cDNA (complementary DNA), and in the case where the bio-material is a protein, the chemical functional group is a secondary antibody.

The measurement part measures the magnetic beads present in the bond structure formed by the immobilization part and the reaction part using the magnetic bead reader, and the value of magnetic beads contained in the bond structure of the bio-material and the chemical functional group is represented by a voltage. As the amount of bound magnetic beads increases, the voltage may increase and thus the amount of magnetic beads may be measured.

In the method of measuring a bio-material using a polymer thin film and magnetic beads according to the present invention, because the bio-material is immobilized on the polymer thin film and inexpensive magnetic beads are used as a labeling compound upon analysis, a wider analysis range can be ensured, compared to silicon wafers, glass, and plastic substrates, and array analysis is possible.

Also the method of measuring a bio-material using a polymer thin film and magnetic beads according to the present invention obviates the need for color reaction and quenching for stopping the reaction, which are essential for conventional ELISA (enzyme-linked immunosorbent assay) or ELIFA (enzyme-linked immunofiltration assay) systems, thus reducing the analysis process by two steps, and there is no change in sample over time and depending on storage conditions, thus achieving easy transportation and storage.

A better understanding of the present invention may be obtained via the following examples that are set forth to illustrate, but are not to be construed as limiting, the present invention.

### Example 1

A liquid was aliquoted to a polymer thin film, and an Easy-Titer® ELIFA system available from Thermoscientific was used in order to form an array such as a 96-well microplate. The polymer thin film was nitrocellulose having a pore size of 0.45 μm. The nitrocellulose polymer thin film was fixed to the ELIFA system, and then washed two times with 100 of deionized (DI) water. 16.0 μl of an antibody solution (HA antibody(NT) cat no. 3427 of H1N1 antibody available from ProSci) was dissolved in 1.584 ml of PBS (Phosphate Buffer Saline), and aliquoted at 220 μl each into wells of the ELIFA system and transferred at 20 μl each into other wells and thus diluted. As such, an antigen solution may be first added. After completion of the above procedure, a vacuum state was formed using a P-pump so that the antibody solution was slowly passed through the polymer thin film for about 5 minutes. The antigen was aliquoted and diluted from 2 μg to 1 pg per 200 μl of PBS, and then sucked in such a manner that the antibody solution was passed through the polymer thin film. A 1% BSA PBS blocking solution was aliquoted at 200 μl each and then sucked again. The magnetic beads used were SiMAG-GOAT-anti-rabbit IgG (Fc-specific) available from Chemicell, Germany. 10 mg of the magnetic beads was washed three times with 1.0 ml of PBS, mixed with 30 ml of P135, bound to a secondary antibody using 1-ethyl-3-(3-dimethylaminopropyl)carbodimide, aliquoted at 200 μl each, sucked in the same manner as above, added with PBS, sucked three times, and then washed three times using a pipette. The polymer thin film was maximally dehumidified using a P-pump, and dried, after which the protein which is the bio-material was measured using a magnetic bead reader.

### Example 2

A bio-material, DNA, was measured in the same manner as in Example 1, with the exception that DNA was immobilized on a polymer thin film (nitrocellulose) in order to measure DNA, and complementary DNA was attached to magnetic beads.

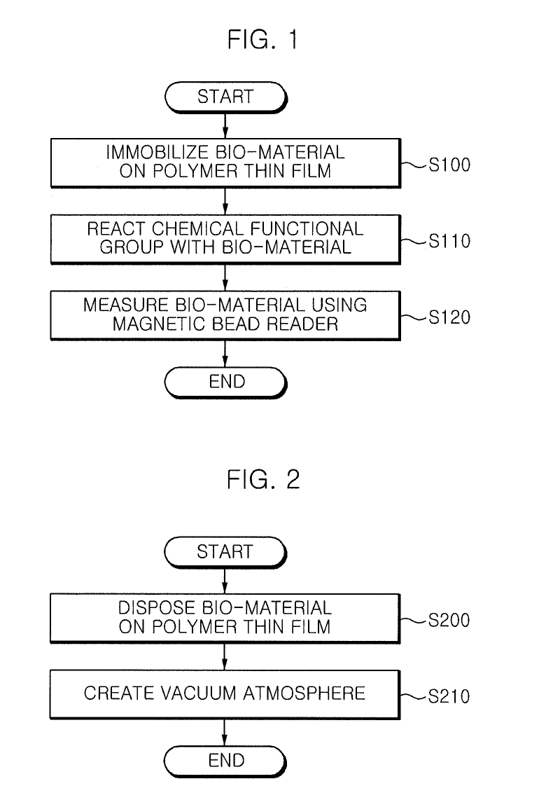

FIG. 1 is a flowchart shoring a process of measuring a bio-material using a polymer thin film and magnetic beads according to the present invention.

With reference to FIG. 1, the method of measuring a bio-material using a polymer thin film and magnetic beads according to the present invention includes immobilizing the bio-material on the nylon or nitrocellulose polymer thin film (S100).

The bio-material immobilized on the polymer thin film such as nylon, nitrocellulose, or the like may include DNA, proteins, etc. Immobilizing the bio-material on the polymer thin film is carried out by means of a moving force generated in the course of the portion including the polymer thin film and the bio-material being made vacuous using a P-pump. The nylon or nitrocellulose polymer thin film enables the analysis of bio-material immobilized in an array form which was not conventionally analyzed using magnetic beads.

Further, the method of measuring a bio-material using a polymer thin film and magnetic beads according to the present invention includes attaching a chemical functional group to magnetic beads and then reacting it with the bio-material on nylon or nitrocellulose (S110).

In the case where the bio-material is DNA, the chemical functional group is cDNA (complementary DNA), and in the case where the bio-material is a protein, the chemical functional group is a secondary antibody in which the secondary antibody may include an antigen, an antigen bound to an antibody, or an antibody. The magnetic beads function as a labeling compound, and are inexpensive and a decrease in activity thereof is low upon change in temperature or exposure to light.

Further, the method of measuring a bio-material using a polymer thin film and magnetic beads according to the present invention includes measuring the bio-material using a magnetic bead reader for detecting the magnetic beads (S120).

The bio-material is represented by a voltage by means of the magnetic beads having the chemical functional group attached thereto. The voltage may increase in proportion to an increase in the amount of bio-material.

FIG. 2 is a flowchart showing a process of immobilizing the bio-material on the polymer thin film according to the present invention.

With reference to FIG. 2, the method of immobilizing the bio-material on the polymer thin film according to the present invention includes disposing the bio-material on the polymer thin film (S200).

The bio-material immobilized on the polymer thin film such as nylon or nitrocellulose may include DNA, proteins, or the like. For example, in the case of proteins, the antigen solution is slowly passed through the polymer thin film, after which the antibody solution is passed through the polymer thin film, so that the antigen-antibody complex is formed on the polymer thin film.

Further, the method of immobilizing the bio-material on the polymer thin film according to the present invention includes creating a vacuum atmosphere to add the bio-material to the polymer thin film (S210).

This immobilizing process is carried out by means of a moving force based on a difference in pressure occurring in the course of creating the vacuum atmosphere.

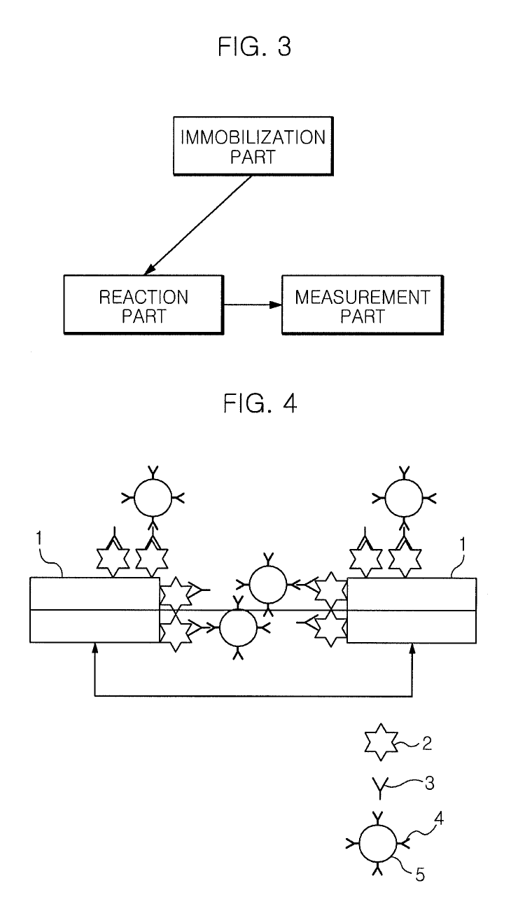

FIG. 3 schematically shows the apparatus for measuring the bio-material using the polymer thin film and the magnetic beads according to the present invention.

With reference to FIG. 3, the apparatus for measuring a bio-material using a polymer thin film and magnetic beads may include an immobilization part, a reaction part, and a measurement part.

The immobilization part is accomplished by means of a moving force generated while the polymer thin film having the bio-material added thereto is made vacuous in order to immobilize the bio-material on the polymer thin film such as nylon or nitrocellulose, and includes the polymer thin film and the bio-material.

The reaction part includes the bio-material bound to the polymer thin film. For example, in the case where the bio-material is DNA, the chemical functional group is cDNA (complementary DNA), and in the case where the bio-material is a protein, the chemical functional group includes a secondary antibody. The chemical functional group includes magnetic beads.

The measurement part measures the magnetic beads present in the bond structure formed by the immobilization part and the reaction part using the magnetic bead reader, and the value of magnetic beads contained in the bond structure of the bio-material and the chemical functional group is represented by a voltage. As the amount of bound magnetic beads increases, the voltage may increase and thus the amount of magnetic beads may be measured.

FIG. 4 schematically shows the bond of a polymer thin film and magnetic beads in order to detect proteins in the process of measuring a bio-material according to the present invention.

As seen in FIG. 4, the antigen 2-antibody 3 bond is formed on the polymer thin film 1, and the secondary antibody 4 which is the chemical functional group attached to the magnetic beads 5 is bound to the antigen 2-antibody 3. More particularly, the liquid is aliquoted to the polymer thin film and an array such as a 96-well microplate is formed. The polymer thin film is fixed to an ELIFA system and washed with DI water, after which an antibody solution is dissolved in PBS and then aliquoted into wells and transferred into other wells and diluted. After completion of the above procedure, a vacuum state is formed using a P-pump so that the antibody solution is slowly passed through the polymer thin film. Also, an antigen is aliquoted into PBS, diluted, and sucked in such a manner that the antibody solution is passed through the polymer thin film. A BSA PBS blocking solution is aliquoted and sucked again. The magnetic beads are washed with PBS, and dissolved again in PBS and thus used. The solution of magnetic beads is aliquoted, sucked in the same manner as above, added with PBS, sucked, and washed using a pipette. The polymer thin film is maximally dehumidified using a P-pump and dried, so that the antigen-antibody is immobilized on the polymer thin film and the secondary antibody bound to the magnetic beads is bonded with the antigen-antibody immobilized on the polymer thin film. As such, the antigen solution and the antibody may be sequentially added and bonded to each other, and the bond to the polymer thin film is not limited by the addition sequence of antigen and antibody.

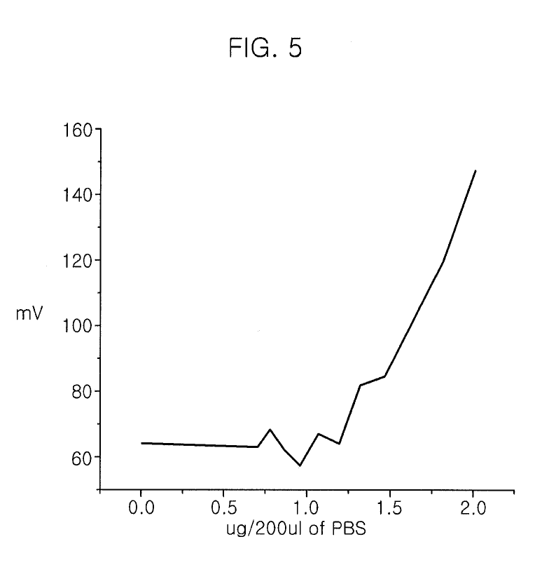

FIG. 5 is a graph showing the results of measuring a virus protein of the H5N1 virus using the process of measuring a bio-material according to the present invention.

With reference to FIG. 5, the amount of bio-material is represented by a voltage using the method of measuring a bio-material according to the present invention. The voltage is slightly increased at a concentration of about 0.85 μg per 200 μl and then decreased to about 1 μg. At this time, the voltage falls in the range of about 60˜65 mV. However, the voltage is increased from the concentration of 1 μg, and the voltage can be seen to increase in proportion to an increase in concentration. The voltage is about 60 mV at 1 μg, and is about 150 mV at 2.0 μg. In the case where the magnetic beads having a size of about 100 nm are used, analysis to the extent of tens of picograms is possible. The method of measuring a bio-material using a polymer thin film and magnetic beads according to the present invention omits color reaction and quenching for stopping the reaction which are essential in a conventional ELISA (enzyme-linked immunosorbent assay) or ELIFA (enzyme-linked immunofiltration assay) system, thus enabling the bio-material to be simply measured.

As described thus far, the present invention provides a method of measuring a bio-material using a polymer thin film and magnetic beads. According to the present invention, a bio-material can be immobilized on a polymer thin film, and inexpensive magnetic beads are used as a labeling compound upon analysis, whereby a wider analysis range can be ensured compared to silicon wafers, glass, and plastic substrates, and array analysis is possible.

Also, the method of measuring a bio-material using a polymer thin film and magnetic beads according to the present invention does not include color reaction and quenching for stopping the reaction, which are essential in conventional ELISA (enzyme-linked immunosorbent assay) or ELIFA (enzyme-linked immunofiltration assay) systems, thus reducing the analysis process by two steps, and there are no changes in sample over time and depending on storage conditions, thus achieving easy transportation and storage.

Although the preferred embodiments of the present invention have been disclosed for illustrative purposes and predetermined terms have also been used, those skilled in the art will appreciate that various modifications, additions, and substitutions are possible, without departing from the scope and spirit of the invention as disclosed in the accompanying claims.

What is claimed is:

1. A method of measuring a bio-material using a polymer thin film and magnetic beads, comprising:
immobilizing a bio-material on a polymer thin film comprising nylon or nitrocellulose;
attaching a chemical functional group to the magnetic beads and then reacting it with the bio-material on the polymer thin film; and
measuring the bio-material using a magnetic bead reader for detecting the magnetic beads.

2. The method of claim 1, wherein the bio-material is DNA or a protein.

3. The method of claim 2, wherein the protein is an antigen-antibody complex.

4. The method of claim 1, wherein the bio-material is immobilized on the polymer thin film in an array form.

5. The method of claim 1, wherein the chemical functional group is cDNA (complementary DNA) when the bio-material is DNA.

6. The method of claim 1, wherein the chemical functional group is a secondary antibody when the bio-material is a protein.

7. The method of claim 1, wherein the magnetic beads have a size of 2.8˜50 nm.

8. A method of immobilizing a bio-material on a polymer thin film, comprising:
disposing the bio-material on the polymer thin film; and
creating a vacuum atmosphere to add the bio-material to the polymer thin film.

9. The method of claim 8, wherein the bio-material is DNA or a protein.

10. The method of claim 9, wherein the protein is an antigen-antibody complex.

11. The method of claim 8, wherein the polymer thin film is nylon or nitrocellulose.

12. The method of claim 8, wherein the immobilizing is performed by means of a moving force based on a difference in pressure occurring in a course of creating the vacuum atmosphere.

13. An apparatus for measuring a bio-material, comprising:
an immobilization part comprising a nylon or nitrocellulose polymer thin film having a bio-material immobilized thereon;
a reaction part for reacting a chemical functional group attached to magnetic beads with the bio-material; and
a measurement part for detecting the magnetic beads using a magnetic bead reader.

14. The apparatus of claim 13, wherein the chemical functional group is cDNA (complementary DNA) when the bio-material is DNA.

15. The apparatus of claim 13, wherein the chemical functional group is a secondary antibody when the bio-material is a protein.
